(19) United States
(12) Patent Application Publication
(10) Pub. No.: US 2019/0230484 A1
(43) Pub. Date: Jul. 25, 2019

(54) POLICY CONTROL WITH MOBILE EDGE COMPUTING

(71) Applicant: NOKIA SOLUTIONS AND NETWORKS OY, Espoo (FI)

(72) Inventor: Juha Antero RASANEN, Espoo (FI)

(21) Appl. No.: 16/300,507

(22) PCT Filed: May 9, 2016
(86) PCT No.: PCT/EP2016/060304

§ 371 Date: Nov. 9, 2018

(51) Int. Cl. H04W 4/24; H04L 29/08

(52) U.S. Cl. CPC H04W 4/24; H04M 15/66; H04L 67/289

(57) ABSTRACT

The present invention addresses a method, apparatus and computer program product for policy control with Mobile Edge Computing. An apparatus of the invention comprises a Mobile Edge Computing server connected between a radio network and a core network including a Packet-Gateway and a Core Network Policy and Charging Control Function, and on which Mobile Edge Computing applications are running, a Mobile Edge Computing Policy and Charging Control Function, and an interface between the Mobile Edge Computing Policy and Charging Control Function and the core network Policy and Charging Control Function, wherein, when a via Mobile Edge Computing application, which is a Mobile Edge Computing application as an intermediate data flow handler, is detected in the core network, a control session to exchange Policy and Charging Control related control and/or synchronization information via the interface is set up.

### FIELD OF THE INVENTION

The present invention generally relates to communication networks, and more specifically relates to a method, apparatus and computer program product for improved Mobile Edge Computing.

### BACKGROUND

Mobile data transmission and data services are constantly making progress, wherein such services provide various communication services, such as voice, video, packet data, messaging, broadcast, etc. In recent years, Long Term Evolution LTE™, and in particular LTE-Advanced™, has been specified, which uses the Evolved Universal Terrestrial Radio Access Network E-UTRAN as radio communication architecture according to 3GPP specification.

Recently, a concept called Mobile Edge Computing MEC has been established. MEC is a network architecture in which applications are run and related processing tasks are performed closer to the cellular customer by pushing applications, data and computing power (services) away from centralized points to the logical extremes of a network. By running applications and performing related processing tasks closer to the cellular customer, network congestion may be reduced and applications may perform better. MEC technology is designed to be implemented at/near the cellular base stations.

The European Telecommunications Standards Institute ETSI is standardizing MEC, see e.g. ETSI GS MEC V1.1.1 (2016-03). Thereby, Policy and charging control PCC is an issue that has not yet been addressed in the MEC standardization.

When a User Equipment UE uses an application running on a MEC server connected to a base station eNB, the application session being between the UE and the application on the MEC server, policy and charging control PCC shall be arranged by the MEC server. This is because the data flow(s) of the application session are not visible to the core network PCC entities.

When a UE uses an application running in or behind the core network, and the session uses a MEC application as an intermediate data flow handler (a session called “via MEC session” and the MEC application called “via MEC application” hereinafter), both the MEC PCC and core network PCC will be involved. The core network PCC is involved inherently as per current 3GPP specifications.

The MEC PCC shall be involved, because it has visibility to both sides of the data flows going through the MEC server, i.e. the radio side and the core network side. The core network PCC has visibility only to the core network data flows. Depending on the measures/manipulation applied by the MEC application to a data flow, the flow on the radio side may be very different from the flow on the core network side.

Applying policy control both on MEC and on core network leads to overlapping and less optimal operations, and may even lead to overlapping and/or controversial results and/or operations, e.g. concerning usage monitoring and control. Applying charging control and charging/accounting both on MEC and on core network leads to distorted charging/accounting in cases where the flow on the radio side is different from the flow on the core network side.

In general, policy control with MEC is desired.

### SUMMARY OF THE INVENTION

Therefore, in order to overcome the drawbacks of the prior art, it is an object underlying the present invention for improving Mobile Edge Computing MEC.

In particular, it is an object of the present invention to provide a method, apparatus and computer program product for policy control with MEC.

This object is achieved by a method, apparatus and computer program product as defined in the accompanying claims.

That is, the present invention provides a solution to MEC versus core network related policy and charging control interworking. The solution according to the invention avoids corrupt/distorted charging/accounting and erroneous usage monitoring and optimizes Quality of Service QoS/policy enforcement.

According to a first aspect of the present invention, there is provided an apparatus, comprising a Mobile Edge Computing MEC server connected between a radio network and a core network including a Packet-Gateway P-GW and a Core Network Policy and Charging Control Function CN PCRF, and on which Mobile Edge Computing applications are running, a Mobile Edge Computing Policy and Charging Control Function MEC PCRF, and an interface between the Mobile Edge Computing Policy and Charging Control Function and the core network Policy and Charging Control Function, wherein, when a via Mobile Edge Computing application, which is a Mobile Edge Computing application as an intermediate data flow handler, is detected in the core network, a control session to exchange Policy and Charging Control related control and/or synchronization information via the interface is set up.

According to a second aspect of the present invention, there is provided an apparatus, which is integrated or attached to a Mobile Edge Computing server connected between a radio network and a core network including a Packet Gateway and core network Policy and Charging Control Function and on which Mobile Edge Computing applications are running, the apparatus forming an interface between the Mobile Edge Computing Policy and Charging Control Function and the Core Network Policy and Charging Control Function, wherein, when a via Mobile Edge Computing application, which is a Mobile Edge Computing application as an intermediate data flow handler, is detected in the core network, a control session to exchange Policy and Charging Control related control and/or synchronization information via the interface is set up.

According to a third aspect of the present invention, there is provided a method, comprising detecting whether a via Mobile Edge Computing application, which is an Mobile Edge Computing application as an intermediate data flow handler, is detected in a core network, setting up a control session to exchange Policy and Charging Control related control and/or synchronization information via an interface, when a via Mobile Edge Computing application is detected, wherein the interface is an interface between a Mobile Edge Computing Policy and Charging Control Function of a Mobile Edge Computing Server, which is connected between a radio network and the core network, and the core network Policy and Charging Control Function of the core network.

According to a fourth aspect of the present invention, there is provided a computer program product comprising computer-executable components which, when the program is run, are configured to carry out the method according to the third aspect.

Advantageous further developments or modifications of the aforementioned exemplary aspects of the present invention are set out in the dependent claims.

According to certain embodiments of the present invention, the Mobile Edge Computing Policy and Charging Control Function is integrated in or attached to the Mobile Edge Computing server.

According to certain embodiments of the present invention, prior to setting up the control session, it is checked whether a User Equipment attached to the radio network and requesting the application is allowed to use via Mobile Edge Computing applications.

Further, according to certain embodiments of the invention, after setting up the control session, the Mobile Edge Computing Policy and Charging Control Function indicates at least one via Mobile Edge Computing application and measures expected from core network Policy and Charging Control Function and/or measures not to be taken by the core network Policy and Charging Control Function (e.g. because they are taken by the Mobile Edge Computing Policy and Charging Control Function), wherein the via Mobile Edge Computing application is indicated by an application ID known by the Mobile Edge Computing and the core network and/or a five tuple, and wherein the measures may comprise e.g. one or more of policy and charging control issues, accounting/charging, usage monitoring control, downlink policing by core network, and uplink policing by Mobile Edge Computing server.

Thereby, according to certain embodiments of the present invention, the Mobile Edge Computing Policy and Charging Control Function may inform the core network Policy and Charging Control Function about the at least one via Mobile Edge Computing application and measures to be taken or not to be taken when the User Equipment attaches the network, and the core network Policy and Charging Control Function pre-configures Policy and Charging Control rules for the via Mobile Edge Computing applications. The Policy and Charging Control rules may be delivered when the Packet Gateway requests them upon detection of the start of a via Mobile Edge Computing application.

Alternatively, according to certain embodiments of the present invention, the Mobile Edge Computing Policy and Charging Control Function informs the core network Policy and Charging Control Function about the at least one via Mobile Edge Computing application and measures to be taken or not to be taken when the start of a via Mobile Edge Computing application is detected by the Mobile Edge Computing server. The Policy and Charging Control rules may be delivered when requested by the Packet Gateway. The Policy and Charging Control rules may also be delivered to and stored in the Packet Gateway without waiting for a request from the Packet Gateway.

Moreover, according to certain embodiments of the present invention, the core network Policy and Charging Control Function and Mobile Edge Computing Policy and Charging Control Function apply their Policy and Charging Control rules to the data flow of the session as long as the stop of the session is detected or the IP context is terminated.

### BRIEF DESCRIPTION OF DRAWINGS

For a more complete understanding of example embodiments of the present invention, reference is now made to the following descriptions taken in connection with the accompanying drawings in which:

FIG. 1 schematically shows a simplified architecture as per embodiments of the invention, with a MEC PCRF and core network PCRF with an interface between them.

FIG. 2 illustrates a method according to certain embodiments of the invention.

FIG. 3 depicts a general structure of an apparatus including a function for policy control with MEC according to certain embodiments of the invention;

FIG. 4 shows a signal flow according to embodiments of the invention, in which the MEC PCRF informs CN PCRF (about applications and required and/or not to be taken measures), when a UE attaches the network and MEC is supported/on the path.

FIG. 5 shows a signal flow according to further embodiments of the invention, in which the MEC PCRF informs CN PCRF (about the application and required and/or not to be taken measures), when the start of a “via MEC server” application is detected.

### DESCRIPTION OF EXEMPLARY EMBODIMENTS

Exemplary aspects of the present invention will be described herein below. More specifically, exemplary aspects of the present invention are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refer to specifications being used as non-limiting examples for certain exemplary network configurations and deployments. Namely, the present invention and its embodiments are mainly described in relation to 3GPP as well as MEC specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Some example versions of the disclosure and embodiments are described with reference to the drawings. In the following, different exemplifying examples will be described using, as an example of a communication network, a cellular wireless communication network, such as an LTE or MEC based system. However, it is to be noted that the present invention is not limited to an application using such types of communication system, but is also applicable in other types of communication systems, be it wireless systems, wired systems or systems using a combination thereof.

Hereinafter, various embodiments and implementations of the present invention and its aspects or embodiments are described using several alternatives. It is generally noted that, according to certain needs and constraints, all of the described alternatives may be provided alone or in any conceivable combination, also including combinations of individual features of the various alternatives. Also, the favorable execution order of features, procedures may differ in different deployments or implementations.

In particular, the following examples versions and embodiments are to be understood only as illustrative examples. Although the specification may refer to “an”, “one”, or “some” example version(s) or embodiment(s) in several locations, this does not necessarily mean that each such reference is to the same example version(s) or embodiment(s), or that the feature only applies to a single example version or embodiment. Single features of different embodiments may also be combined to provide other embodiments. Furthermore, words “comprising” and “including” should be understood as not limiting the described embodiments to consist of only those features that have been mentioned and such example versions and embodiments may also contain also features, structures, units, modules etc. that have not been specifically mentioned.

In general, a wireless communication network comprises plural network elements, such as evolved NodeB's (eNB; i.e. base station in UMTS or LTE/LTE-A environment), User Equipments UE (e.g. mobile phone, smart phone, Computer, etc.), controllers, interfaces, etc, and in particular any equipment used in the provision of a communications service.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a base station and a communication network besides those described in detail herein below.

As already indicated above, the present invention provides policy control with MEC.

According to the present invention, a MEC server comprises a policy and charging control PCC entity, or policy and charging rules function PCRF, either integrated in or connected to the MEC server.

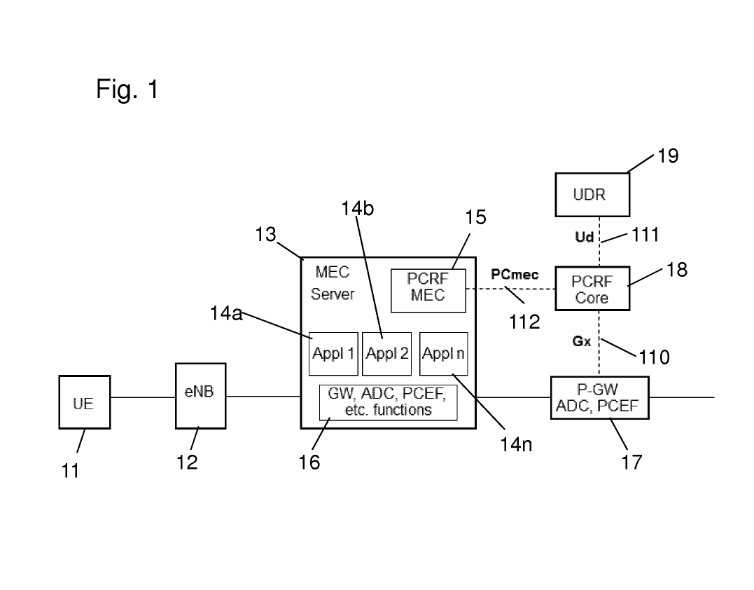

FIG. 1 schematically shows a simplified architecture as per embodiments of the invention, with a MEC PCRF and core network PCRF with an interface between them.

According to the example architecture shown in FIG. 1, the MEC PCRF is integrated in the server. However, the MEC PCRF may also be attached/connected to the MEC. Communication concerning PCC operations shall be possible between the MEC environment and core network. This is described with the ‘PCmec’ interface between MEC PCRF and CN PCRF in FIG. 1.

In FIG. 1, a User Equipment UE 11 and a base station eNB 12 are part of a radio network which is connected to a MEC Server 13, on which applications 14a, 14b, 14n are able to be run. The MEC Server 13 comprises a MEC PCRF 15 as well as means for Gateway-, Application detection and control ADC-, Policy and Charging enforcement function PCEF-, etc,—functions 16. The MEC Server 13 is connected to a core network e.g. via a Packet Gateway P-GW 17, which may have functionality for ADC and PCEF. The core network CN further comprises a core network PCRF 18 connected e.g. via the Gx interface 110 to the P-GW, and a User Data Repository UDR 19, which is connected to the CN PCRF 18 e.g. via the Ud interface 111. Furthermore, an interface PCmec 112 is provided between the MEC PCRF 15 and the CN PCRF 18.

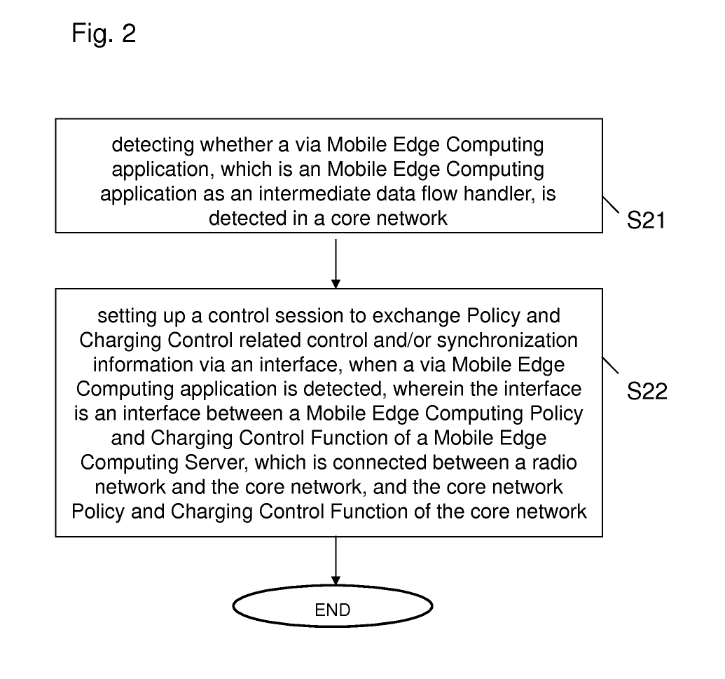

FIG. 2 illustrates a method according to certain embodiments of the invention.

In Step S21, it is detected whether a ‘via MEC application’, which is a MEC application as an intermediate data flow handler, is detected in a core network.

In Step S22, a control session to exchange Policy and Charging Control related control and/or synchronization information via an interface is set up, when a via MEC application is detected.

Thereby, the interface is an interface between a MEC PCRF of a MEC Server, which is connected between a radio network and the core network (as e.g. depicted in FIG. 1), and the CN PCRF of the core network.

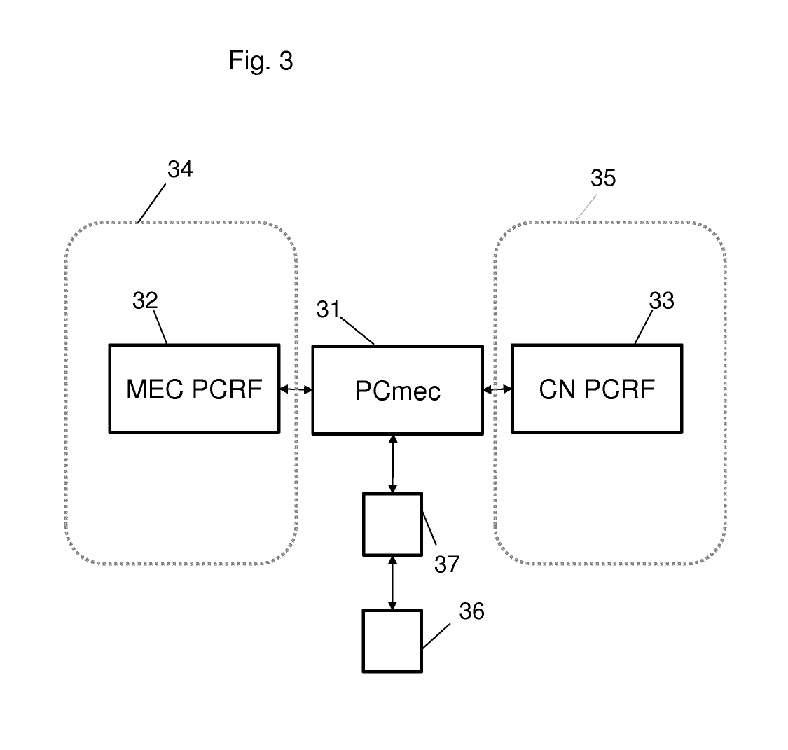

In FIG. 3, a diagram illustrating a configuration of an exemplary apparatus implementing a function for policy control with MEC according to some example versions of the disclosure is shown. It is to be noted that the apparatus may comprise elements or functions, such as a chipset, a chip, a module etc., which can also be part of the apparatus or attached as a separate element to the apparatus, or the like. It should be understood that each block and any combination thereof may be implemented by various means or their combinations, such as hardware, software, firmware, one or more processors and/or circuitry.

The apparatus shown in FIG. 3 may comprise a processing function, control unit or processor 37 such as a CPU or the like, which is suitable for executing instructions given by programs or the like related to the network element control procedure.

The processor 31 is configured to execute processing related to the above described policy control with MEC. In particular, the processor 31 may control an interface PCmec 31 between a MEC PCRF 32 and a CN PCRF 33. Thereby, the CN PCRF 33 is part of a core network CN 35, and the MEC PCRF 32 is part of a mobile network edge server 34. It is to be noted that the MEC PCRF 32 may also be provided separate from the mobile network edge server 34, as long as it can exchange signals with the mobile network edge server 34.

In FIG. 3, reference sign 36 denotes a memory usable, for example, for storing data and programs to be executed by the processor 37 and/or as a working storage of the processor 37.

According to certain embodiments of the invention, when a UE attaches to a network and sets up an IP context with the P-GW, the MEC server involved in the configuration notices the event. The MEC server may check whether the user/UE is allowed to use ‘via MEC applications’, i.e. a kind of authorization, where the MEC PCRF and/or an internal or external database may be involved.

If the user/UE is allowed to use ‘via MEC applications’ available on the MEC server, the MEC PCRF and CN PCRF set up a control session to exchange PCC related control and/or synchronization information. This may take place in two different ways.

That is, firstly, a MEC PCRF initiates the operation. Thereby, the MEC PCRF may deduce the need for the session from the fact that the user/UE is allowed to use “via MEC applications” available on the MEC server. MEC PCRF may find the CN PCRF entity (selected by P-GW) e.g. as per current 3GPP practices/procedures.

Secondly, the CN PCRF initiated operation. CN PCRF may deduce the need for the session from a parameter, e.g. APN related to MEC, received from P-GW upon IP context setup. CN PCRF may find the MEC PCRF entity e.g. as per current 3GPP practices/procedures, or alternatively, CN PCRF may deduce the contact information or identity of the MEC PCRF e.g. from a parameter, e.g. the IP address, received from P-GW upon IP context setup.

After setting up the session between the PCRF entities, MEC PCRF indicates at least one ‘via MEC application’ and measures expected from or not to be taken by CN PCRF, when the application is detected in the core network. The application may be indicated e.g. by an application ID known in both environments (i.e. MEC and core network) and/or a five tuple. The measures may comprise e.g. policy and/or charging control issues, accounting/charging, usage monitoring control, downlink policing by core network, uplink policing by MEC server, etc.

The indication of application(s) and related measures (to be taken or not to be taken) from MEC PCRF to CN PCRF, and the delivery of PCC Rules from CN PCRF to P-GW, may take place in different ways.

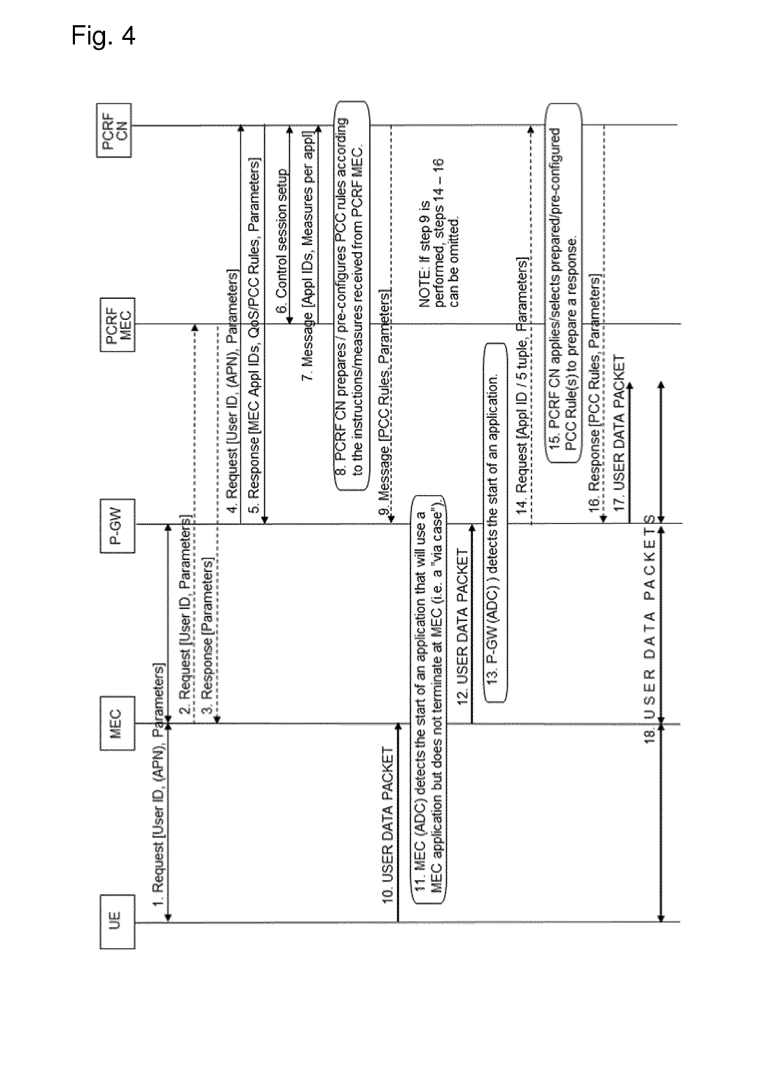

On the one hand, the MEC PCRF informs the CN PCRF about applications and required or not to be taken measures, when a UE attaches the network, for details refer to FIG. 4. In this case MEC PCRF may indicate the ‘via MEC application(s)’ that the user/UE is allowed to use and the relevant measures expected or not to be taken by CN PCRF. CN PCRF may prepare/pre-configure PCC rule(s) for the application(s) to be ready, when P-GW requests them upon detection of the start of an application. As an alternative embodiment, the delivery of the PCC Rule(s) can be expedited by the CN PCRF sending the PCC rule(s) to the P-GW without waiting for a request from P-GW (step 9 in FIG. 4), meaning that the rules may be stored by the P-GW for possible use as long as the UE's IP context is on or the rules are updated or deleted, and steps 14-16 of FIG. 4 can be omitted.

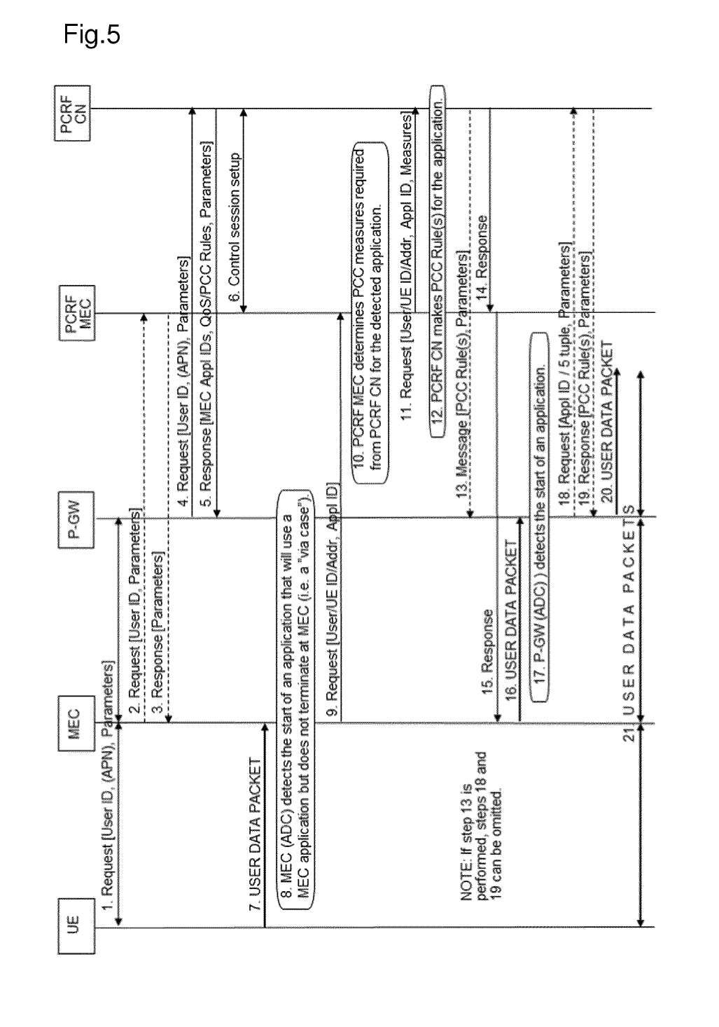

On the other hand, the MEC PCRF informs the CN PCRF about an application and required or not to be taken measures, when the start of the application is detected by (ADC in) the MEC server, for details refer to FIG. 5. In FIG. 5 the responses 14 and 15 may, as an alternative embodiment, take place earlier to speed up the operations. As another alternative embodiment, the PCC rule delivery can be expedited by the CN PCRF sending the PCC rule(s) to P-GW without waiting for a request from P-GW (step 13 of FIG. 5).

The CN PCRF and the MEC PCRF apply their PCC rules to the data flow(s) of the session, step 18 in FIG. 4 and step 21 in FIG. 5, as long as the stop of the session is detected or the IP context is terminated (as per the current 3GPP specifications).

In particular FIGS. 4 and 5 describe two somewhat different embodiments in further detail. In this regard, each of FIGS. 4 and 5 schematically shows signaling between a UE, a MEC, a P-GW, a MEC PCRF, and a CN PCRF.

That is, FIG. 4 shows a signal flow according to embodiments of the invention, in which the MEC PCRF informs CN PCRF (about applications and required or not to be taken measures), when a UE attaches the network and MEC is supported/on the path.

In step 1 of FIG. 4, a UE requests performing an MEC application. Thereby, e.g. User ID, APN and/or parameters are exchanged between the UE, the MEC and the P-GW. As becomes apparent from steps 2 and 3, said request may be forwarded from the MEC to the MEC PCRF, which in turn transmits a respective response. As depicted in steps 4 and 5, said request may be forwarded from the P-GW to the CN PCRF, which in turn transmits a respective response comprising e.g. MEC application IDs, QoS/PCC rules and/or further parameters. In step 6 a control session between the MEC PCRF and the CN PCRF is set up. Thereby, in step 7, a message including e.g. Application IDs, measures to be taken or not to be taken per application, etc. is transmitted from the MEC PCRF to the CN PCRF. Then, in step 8, the CN PCRF prepares/pre-configures PCC rules according to instructions/measures received from the MEC PCRF. In step 9, a message including e.g. PCC rules and further parameters is provided from the CN PCRF to the P-GW. When a user data packed is transmitted from the UE to the MEC in step 10, the MEC (Application detection and control ADC) detects in step 11 the start of an application that will use a MEC application but does not terminate at MEC (i.e. a ‘via case’). The user data packed is forwarded to the P-GW in step 12, and the P-GW (ADC) detects the start of an application in step 13. In step 14, a request for e.g. Application ID and/or 5 tuple, as well as further parameters is transmitted from the P-GW to the CN PCRF. In turn, in step 15, the CN PCRF applies/selects prepared/pre-configured PCC rule(s) to prepare a response, and then transmits the response comprising e.g. PCC rules and parameters to the P-GW. Then, the P-GW forwards the user data packet in step 17. In step 18, the data flow(s) under consideration the PCC rules to the data flow(s) of the session is applied.

It is to be noted that step 9 of FIG. 4 is optional, In case step 9 is performed, steps 14 to 16 can be omitted.

FIG. 5 shows a signal flow according to further embodiments of the invention, in which the MEC PCRF informs CN PCRF (about the application and required or not to be taken measures), when the start of a ‘via MEC server’ application is detected.

The steps 1 to 6 of FIG. 7 basically correspond to steps 1 to 6 of FIG. 6, such that a repetition thereof is omitted.

When a user data packed is transmitted from the UE to the MEC in step 7, in step 8 the MEC (Application detection and control ADC) detects the start of an application that will use a MEC application but does not terminate at MEC (i.e. a ‘via case’). A Request for e.g. User/UE ID/Address, Application ID is transmitted from the MEC to the MEC PCRF in step 9. In step 10, the MEC PCRF determines PCC measures required from or not to be taken by CN PCRF for the detected application. A respective request for e.g. User/UE ID/Address, Application ID and the measures is transmitted from the MEC PCRF to the CN PCRF in step 11. In step 12, the CN PCRF makes PCC Rule(s) for the application. Then, in step 13, the CN PCRF forwards a message including e.g. PCC rule(s) and parameters to the P-GW and transmits a response to the MEC PCRF in step 14. In step 15 the MEC PCRF forwards the response to the MEC, and in turn, in step 16, the MEC forwards the user data packet to the P-GW. Thereby, in step 17, the P-GW detects the start of an application. In step 18, a request for e.g. Application ID/5 tuple and/or further parameters is transmitted from the P-GW to the CN PCRF, and the CN PCRF transmits a respective response in step 19 to the P-GW. Then, the P-GW forwards the user data packet in step 20. In step 21, the data flow(s) under consideration the PCC rules to the data flow(s) of the session is applied.

It is to be noted that step 13 of FIG. 5 is optional. In case step 13 is performed, steps 18 to 19 can be omitted.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It should also be understood that the above described example embodiments of the invention are not to be viewed in a limiting sense. Rather, there are several variations and modifications which may be made without departing from the scope of the present invention as defined in the appended claims.

The following meanings for the abbreviations used in this specification apply:
3GPP 3^{rd} generation partnership project
ADC Application detection and control
CN Core network
eNB Evolved Node B, E-UTRAN Node B
EPC Evolved packet core
ETSI European telecommunications standards institute
GW Gateway
ID Identity, Identifier
IP Internet protocol
ISG Industry specification group
LTE Long term evolution
MEC Mobile edge computing
PCC Policy and charging control
PCEF Policy and charging enforcement function
PCRF Policy and charging control function
P-GW Packet data network gateway
RNI S Radio network information service
UDR User data repository
UE User equipment

1. An apparatus, comprising:
a Mobile Edge Computing server connected between a radio network and a core network including a Packet-Gateway and a Core Network Policy and Charging Control Function, and on which Mobile Edge Computing applications are running;
a Mobile Edge Computing Policy and Charging Control Function; and
an interface between the Mobile Edge Computing Policy and Charging Control Function and the core network Policy and Charging Control Function,
wherein, when a via Mobile Edge Computing application, which is a Mobile Edge Computing application as an intermediate data flow handler, is detected in the core network, a control session to exchange Policy and Charging Control related control and/or or synchronization information via the interface is set up.

2. An apparatus, which is integrated or attached to a Mobile Edge Computing server connected between a radio network and a core network including a Packet Gateway and core network Policy and Charging Control Function and on which Mobile Edge Computing applications are running, the apparatus forming an interface between the Mobile Edge Computing Policy and Charging Control Function and the Core Network Policy and Charging Control Function,
wherein, when a via Mobile Edge Computing application, which is a Mobile Edge Computing application as an intermediate data flow handler, is detected in the core network, a control session to exchange Policy and Charging Control related control or synchronization information via the interface is set up.

3. The apparatus according to claim 1, wherein the Mobile Edge Computing Policy and Charging Control Function is integrated in or attached to the Mobile Edge Computing server.

4. The apparatus according to claim 1, wherein, prior to setting up the control session, it is checked whether a User Equipment attached to the radio network and requesting the application is allowed to use via Mobile Edge Computing applications.

5. The apparatus according to claim 1, wherein, after setting up the control session, the Mobile Edge Computing Policy and Charging Control Function indicates at least one via Mobile Edge Computing application and measures expected from or not to be taken by core network Policy and Charging Control Function,
wherein the via Mobile Edge Computing application is indicated by an application ID known by the Mobile Edge Computing and the core network and/or a five tuple, and
wherein the measures comprise at least one of policy or charging control issues, accounting/charging, usage monitoring control, downlink policing by core network, and uplink policing by Mobile Edge Computing server.

6. The apparatus according to claim 5, wherein the Mobile Edge Computing Policy and Charging Control Function informs the core network Policy and Charging Control Function about the at least one via Mobile Edge Computing application and measures to be taken or not to be taken when the User Equipment attaches the network, and the core network Policy and Charging Control Function pre-configures Policy and Charging Control rules for the via Mobile Edge Computing applications.

7. The apparatus according to claim 6, wherein the Policy and Charging Control rules are delivered when the Packet Gateway requests them upon detection of the start of a via Mobile Edge Computing application.

8. The apparatus according to claim 5, wherein the Mobile Edge Computing Policy and Charging Control Function informs the core network Policy and Charging Control Function about the at least one via Mobile Edge Computing application and measures to be taken or not to be taken when the start of a via Mobile Edge Computing application is detected by the Mobile Edge Computing server.

9. The apparatus according to claim 8, wherein the Policy and Charging Control rules are delivered when requested by the Packet Gateway.

10. The apparatus according to claim 6, wherein the Policy and Charging Control rules are delivered to and stored in the Packet Gateway without waiting for a request from the Packet Gateway.

11. The apparatus according to claim 6, wherein the core network Policy and Charging Control Function and Mobile Edge Computing Policy and Charging Control Function apply their Policy and Charging Control rules to the data flow of the session as long as the stop of the session is detected or the IP context is terminated.

12. A method, comprising:
detecting whether a via Mobile Edge Computing application, which is an Mobile Edge Computing application as an intermediate data flow handler, is detected in a core network;
setting up a control session to exchange Policy and Charging Control related control or synchronization information via an interface, when a via Mobile Edge Computing application is detected,
wherein the interface is an interface between a Mobile Edge Computing Policy and Charging Control Function of a Mobile Edge Computing Server, which is connected between a radio network and the core network, and the core network Policy and Charging Control Function of the core network.

13. The method according to claim 12, wherein the Mobile Edge Computing Policy and Charging Control Function is integrated in or attached to the Mobile Edge Computing server.

14. The method according to claim 12, wherein, prior to setting up the control session, it is checked whether the User Equipment attached to the radio network and requesting the application is allowed to use via Mobile Edge Computing applications.

15. The method according to claim 12, wherein, after setting up the control session, the Mobile Edge Computing Policy and Charging Control Function indicates at least one via Mobile Edge Computing application and measures expected from or not to be taken by core network Policy and Charging Control Function,
wherein the via Mobile Edge Computing application is indicated by an application ID known by the Mobile Edge Computing and the core network or a five tuple, and
wherein the measures comprise at least one of policy or charging control issues, accounting/charging, usage monitoring control, downlink policing by core network, and uplink policing by Mobile Edge Computing server.

16. The method according to claim 15, wherein the Mobile Edge Computing Policy and Charging Control Function informs the core network Policy and Charging Control Function about the at least one via Mobile Edge Computing application and measures to be taken or not to be taken when the User Equipment attaches the network, and the core network Policy and Charging Control Function pre-configures Policy and Charging Control rules for the via Mobile Edge Computing applications.

17. The method according to claim 16, wherein the Policy and Charging Control rules are delivered when the Packet Gateway requests them upon detection of the start of a via Mobile Edge Computing application.

18. The method according to claim 15, wherein the Mobile Edge Computing Policy and Charging Control Function informs the core network Policy and Charging Control Function about the at least one via Mobile Edge Computing application and measures to be taken or not to be taken when the start of a via Mobile Edge Computing application is detected by the Mobile Edge Computing server.

19. The method according to claim 18, wherein the Policy and Charging Control rules are delivered when requested by the Packet Gateway.

20. The method according to claim 16, wherein the Policy and Charging Control rules are delivered to and stored in the Packet Gateway without waiting for a request from the Packet Gateway.

21. The method according to claim 16, wherein the core network Policy and Charging Control Function and Mobile Edge Computing Policy and Charging Control Function apply their Policy and Charging Control rules to the data flow of the session as long as the stop of the session is detected or the IP context is terminated.

22. A computer program product embodied on a non-transitory computer-readable medium, said product, comprising software code portions for performing the steps of claim 12 when said product is run on a computer.

23. (canceled)
